(19) United States
(12) Patent Application Publication
(10) Pub. No.: US 2008/0170631 A1
(43) Pub. Date: Jul. 17, 2008

(54) System and method for notched spectrum modulation of radio frequency carrier waves

(75) Inventor: Joseph A. Bobier, Sunrise, FL (US)

Correspondence Address: DENNIS L. COOK, ESQ.;THE LAW OFFICES OF DENNIS L COOK PLLC, 12718 DUPONT CIRCLE, TAMPA, FL, 33626, US

(73) Assignee: xG Technology, Inc., Sarasota, FL (US)

(21) Appl. No.: 12/008,571

(22) Filed: Jan. 11, 2008

Related U.S. Application Data
(60) Provisional application No. 60/880,638, filed on Jan. 16, 2007.

(51) Int. Cl. H04B 14/04

(52) U.S. Cl. 375/242

(57) ABSTRACT

Pulse modulation is used in many forms and generally consists of a pulse of radio energy, that can be as simple as On-Off Keying (OOK) to more complex systems like Pulse Position Modulation (PPM) and even more advanced systems. In this application a system and method of adding complexity to the transmission system known as pulse modulation by placing one or more notches in the radio pulse spectrum at the transmitter to indicate a combination of bits or symbols is disclosed.

### CROSS-REFERENCE TO RELATED APPLICATION

The present application claims the benefit of previously filed co-pending Provisional Patent Application Ser. No. 60/880,638.

### FIELD OF THE INVENTION

This invention addresses the need to transport high bit-rate data over wired or wireless means using specially modulated radio frequency carrier waves. Specifically, This disclosure describes a new method of radio modulation that improves simple impulse radio transmission systems.

### BACKGROUND OF THE INVENTION

Modulation is the fundamental process in any communication system. It is a process to impress a message (voice, image, data, etc.) on to a carrier wave for transmission. A band-limited range of frequencies that comprise the message (baseband) is translated to a higher range of frequencies. The band-limited message is preserved, i.e., every frequency in that message is scaled by a constant value. The three key parameters of a carrier wave are its amplitude, its phase and its frequency, all of which can be modified in accordance with an information signal to obtain the modulated signal.

There are various shapes and forms of modulators. For example conventional Amplitude Modulation uses a number of different techniques for modulating the amplitude of the carrier in accordance with the information signal. These techniques have been described in detail in “Modern Analog and Digital Communication Systems” by B. P. Lathi. Similarly conventional Frequency/Phase Modulation uses a number of different methods described in a number of textbooks. In all these techniques, carrier (which is a high frequency sinusoidal signal) characteristics (either amplitude, frequency, phase or combination of these) are changed in accordance with the data (or information signal). Thus there has been two major components of a modulated signal. One is the information carrying signal and the other is the high frequency carrier. An unconventional system and method of modulation which creates a new type of information-carrying signal is described in this document.

Communication systems that have emerged in recent years include mono-pulse and Ultra-Wide Band communication systems. The problem with these systems is that all mono-pulse or Ultra-Wide Band communications systems form Power Spectrum Densities that tend to span very wide swaths of the radio spectrum. For instance the FCC has conditionally allowed limited power use of UWB from 3.2 GHz to 10 GHz. These systems must make use of very wide sections of radio spectrum because the transmit power in any narrow section of the spectrum is very low. Generally any 4 KHz section of the affected spectrum will contain no more than −42 dbm of UWB spectral power. Correlating receivers are used to “gather” such very wide spectral power and concentrate it into detectable pulses. Interfering signals are problematic. Since the communication system is receiving energy over a very wide spectrum, any interfering signal in that spectrum must be tolerated and mitigated within the receiver. Many schemes exist to mitigate the interference. Some of these include selective blocking of certain sections of spectrum so as not to hear the interferer, OFDM schemes that send redundant copies of the information in the hope that at least one copy will get through interference, and other more exotic schemes that require sophisticated DSP algorithms to perform advanced filtering. In addition, UWB systems have somewhat of a “bad reputation” because they at least have the potential to cause interference. A heated discourse has gone on for years over the potential that UWB systems can cause interference to legacy spectrum users.

Tri-State Integer Cycle Modulation (TICM) and other Integer Cycle Modulation techniques, which has now become known by its commercial designation, xMax, were designed by the inventor of this application to help alleviate this massive and growing problem. Its signal characteristics are such that absolute minimal sideband energy is generated during modulation but that its power spectrum density is quite wide relative to the information rate applied. Also, a narrower section of the power spectrum output can be used to represent the same information. The technique of notched spectrum modulation disclosed herein is primarily applicable to these types of integer cycle and pulse modulation systems.

### BRIEF SUMMARY OF THE INVENTION

The invention disclosed in this application uses any integer cycle or impulse type modulation and more particularly is designed to work with a method of modulation named Tri-State Integer Cycle Modulation (TICM) which has been previously disclosed in U.S. Pat. No. 7,003,047 issued Feb. 21, 2006, filed by the inventor of this disclosure and is now known by its commercial designation, xMax. Pulse modulation is used in many forms and generally consists of a pulse of radio energy that can be as simple as On-Off Keying (OOK) to more complex systems like Pulse Position Modulation (PPM) and even more advanced systems such as xMax. The present invention adds complexity to the transmission system known as pulse modulation by placing a notch in the radio pulse spectrum at the transmitter.

For a fuller understanding of the nature and objects of the invention, reference should be made to the following detailed description taken in connection with the accompanying drawings.

### DESCRIPTION OF THE DRAWINGS

For a fuller understanding of the nature and objects of the invention, reference should be made to the accompanying drawings, in which:

FIG. 1 is a representation of the power spectrum of a pulse;

FIG. 2 is a representation of the Time-Domain plot of a pulse;

FIG. 3 is a representation of the power spectrum of a notch-filtered pulse;

FIG. 4 is a representation of the Time-Domain plot of a notch-filtered pulse;

FIG. 5 is a representation of the power spectrum of a notch-filtered pulse;

FIG. 6 is a representation of the Time-Domain plot of a notch-filtered pulse; and

FIG. 7 is a representation of the power spectra comparison.

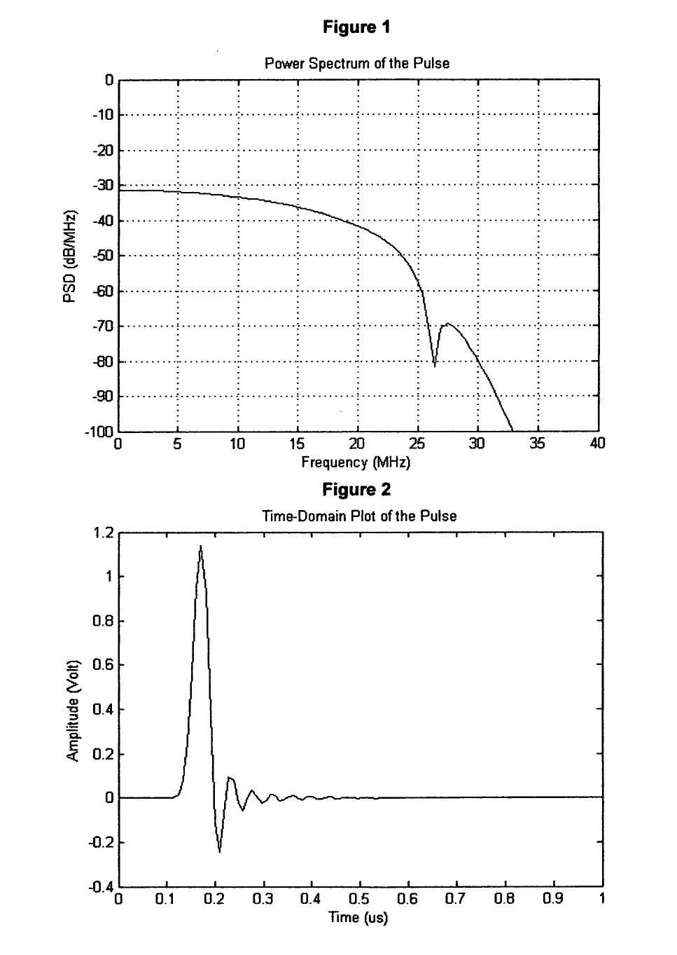

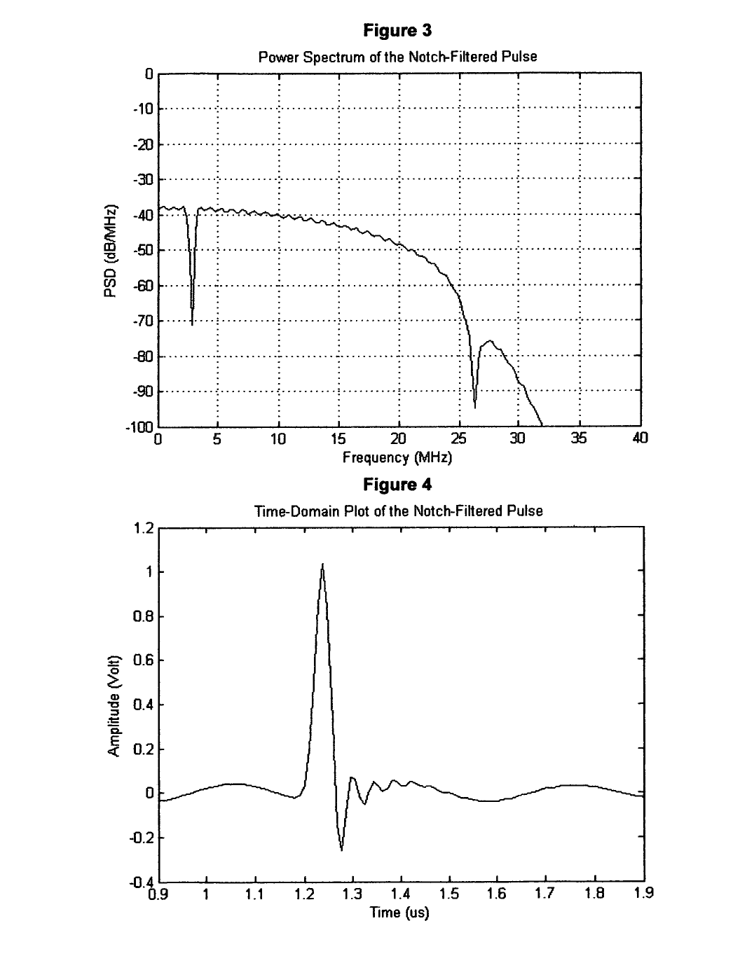

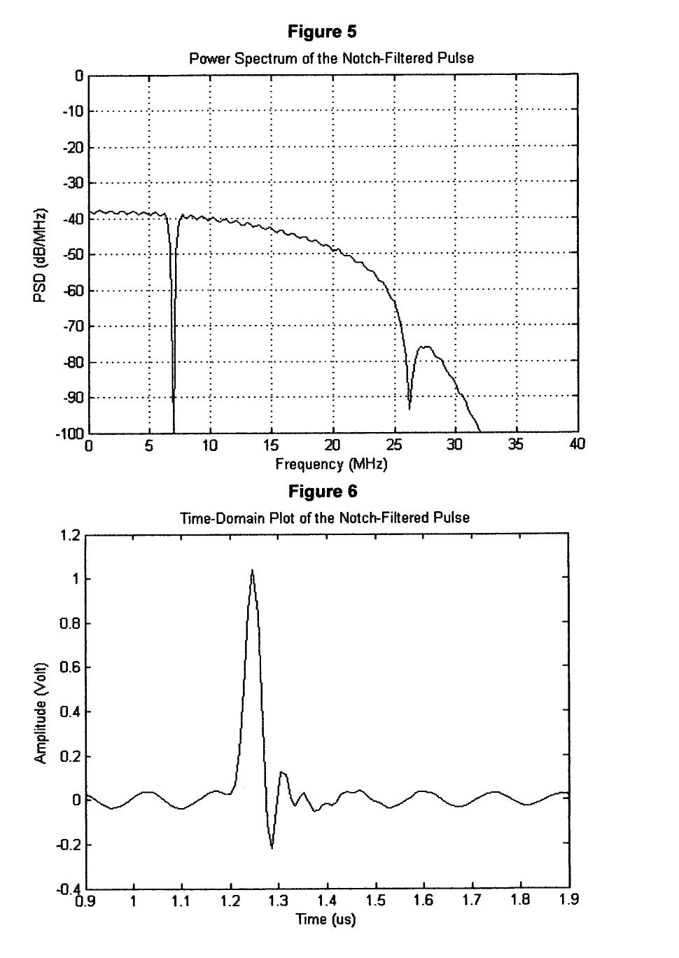

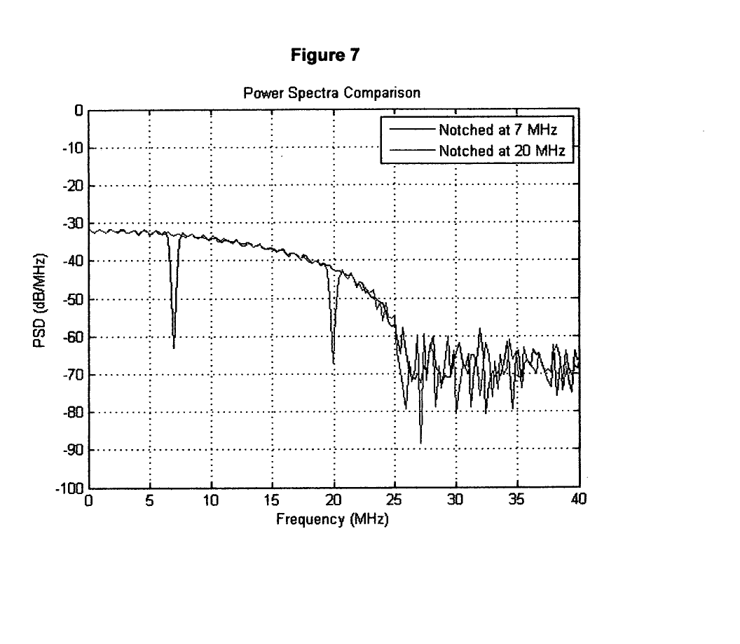

### DETAILED DESCRIPTION OF THE INVENTION

Generally radio modulation methods are categorized into two groups: first order and high order. First order systems are characterized by simplicity and robustness. Such systems include AM, FM, impulse radio, phase modulation and FSK. These systems typically operate at the low signal to noise ratios. However they are not able to transport as much information as higher order systems in a given amount of channel bandwidth. Therefore high order systems are devised that can represent more information per symbol. Some of these systems include QUAM, PSK and the like. However these systems become less tolerant of noise as the complexity of the modulation system increases. The spectral efficiency of any radio system can be expressed as bits/Hertz (b/Hz). Many modern digital data radio transmission systems use adaptive high order systems that can adjust the modulation complexity in response to channel conditions, i.e. as the channel conditions degrade in any of a number of given ways, the modulation complexity can decrease to gain more reliability, at the expense of data transmission rate.

The present invention adds complexity to the transmission system known as pulse modulation. Pulse modulation is used in many forms and generally consists of a pulse of radio energy that can be as simple as On-Off Keying (OOK) to more complex systems like Pulse Position Modulation (PPM) and even more advanced systems such as xMax.

These systems have in common the use of a radio pulse of some specific time duration to represent information or a symbol. Using a modeled system with spectrum from 0 to 26 MHz as an example, the radio pulse would look similar to FIG. (1) in the frequency domain. The time minimum duration would depend upon the bandwidth of the channel of operation. FIG. (2) depicts the same pulse in the time domain.

The model used to simulate this system uses a low pass filter to limit substantial channel response to lower than 26 MHz. Regardless of the coding, pulse positioning or other adjunct to the pulse transmission system, the essential pulse and its spectrum remain simple pulses of radio energy. The improvement now described teaches a method of modification of the pulse spectral content so as to add complexity to the simple radio pulse making it capable of becoming a more complex symbol, or a higher order of modulation. The result will be an improvement in spectral efficiency.

Again, considering FIG. (1) the radio spectrum of the transmitted pulse is essentially un-remarkable, being largely homogenous across the channel. Consider then that looking to FIG. (3), it is possible to have the transmitter place a notch in the radio pulse spectrum. In essence, transmit the pulse, with a portion of the radio energy removed. The pulse in the time domain looks little affected in FIG. (4), yet the notch in FIG. (3) is easily distinguished. Since the notch in the radio spectrum is easily distinguishable, a method of adding complexity to the simple pulse transmission of this non-coherent system is created.

Several ways to use this system of “marking” become evident. The position of the notch can indicate a combination of bits or symbol. Such complexity, or order ranking, is determined by the number of possible notch positions in the system. For instance 256 notch positions would indicate 8 bits of data per radio pulse. The receiver would simply locate the notch position and reference a symbol table. This is very easily done by a DSP. FIG. (5) is the same pulse with the notch moved to another center frequency. FIG. (6) shows that the pulse itself is still largely unaffected.

Multiple notches can be formed simultaneously. See FIG. (7) where one pulse contains two notches. The order or complexity of such a system would be determined by the number of notches formed and transmitted. For instance, if a “1” is represented by the presence of the notch and a “0” is represented by the lack of a notch, and specific locations in the pulse spectrum are assigned notch positions, several parallel bits can be transmitted. By further example, if 32 notch positions are assigned, 32 bits could be transmitted per radio pulse. Other methods of using the notches as a coding system of course exist and are incorporated as being obvious.

Since certain changes may be made in the above described RF signal modulation system and spectrum notching method without departing from the scope of the invention herein involved, it is intended that all matter contained in the description thereof, or shown in the accompanying figures, shall be interpreted as illustrative and not in a limiting sense.

What is claimed is:

1. A method of generating a radio frequency signal capable of transmission and reception of coded digital information comprising:
generating a radio frequency pulse comprised of a selected spectrum of radio energy;
marking said radio frequency pulse by removing a selected spectral portion or portions of the radio energy in said radio frequency pulse resulting in one or more notches in the spectrum of said radio frequency pulse creating a notched radio frequency pulse; and,
correlating said marking of said notched radio frequency pulse with coded digital information to indicate a combination of bits or symbols.

2. The method of claim 1 wherein said marking of said radio frequency pulse is done by filtering.

3. The method of claim 1 wherein said correlating is accomplished using a symbol table.

4. The method of claim 3 wherein the correlation is further accomplished using a digital signal processor.

5. A system for generating a radio frequency signal capable of transferring coded digital information comprising:
a generator used for generating a radio frequency pulse comprised of a selected spectrum of radio energy in electrical communications with a filtering means;
said filtering means used for marking said radio frequency pulse by removing a selected spectral portion or portions of the radio energy in said radio frequency pulse resulting in one or more notches in the spectrum of said radio frequency pulse creating a notched radio frequency pulse in electrical communication with a symbol table; and,
said symbol table used for correlating said marking of said notched radio frequency pulse with coded digital information to indicate a combination of bits or symbols.

6. The system of claim 5 further comprising a digital signal processor used for correlating said marking of said notched radio frequency pulse with coded digital information to indicate a combination of bits or symbols in electrical communication with said symbol table.
